(19) United States
(12) Patent Application Publication
(10) Pub. No.: US 2014/0321918 A1
(43) Pub. Date: Oct. 30, 2014

(54) Flow treatments in evaporative desorption processes

(71) Applicant: Reterro, Inc., Pleasanton, CA (US)

(72) Inventor: Patrick Richard Brady, Sisters, OR (US)

(73) Assignee: Reterro, Inc., Pleasanton, CA (US)

(21) Appl. No.: 14/264,024

(22) Filed: Apr. 28, 2014

Related U.S. Application Data
(60) Provisional application No. 61/817,308, filed on Apr. 29, 2013.

(51) Int. Cl. B09C 1/06; B09C 1/00

(52) U.S. Cl. CPC B09C 1/06; B09C 1/005
USPC 405/128.85

(57) ABSTRACT

Treating an immediate exhaust of a thermal desorption chamber can improve the safety of the treatment process, such as reducing potential explosion or flammability when treating highly contaminated soil. Mean free paths of the exhaust gas exiting a thermal desorption chamber are restricted to limit the flame propagation and explosion fronts. For example, a section of the gas exhaust conduit can be filled with a porous media, which can assist in reducing or eliminating the potential explosion hazard in the conduit. Temperature and concentration of flammable elements can be monitored and controlled to prevent explosion hazards. An isolation valve and a pressure relief chimney can also be coupled to the exhaust of the thermal desorption chamber.

This application claims priority from U.S. Provisional Patent Application Ser. No. 61/817,308, filed on Apr. 29, 2013, entitled “Flow treatments in evaporative desorption processes”; which is incorporated herein by reference.

### BACKGROUND

The use of petroleum hydrocarbons as a fuel source is ubiquitous in society. Consequently, petroleum hydrocarbon products are stored and handled in great quantities. One risk associated with the storage and handling of petroleum hydrocarbons is the potential for spillages during handling or the potential for leakage during storage. Due to the negative environmental impact associated with spills and leakages of petroleum hydrocarbons, rules have been established at the local, state and federal levels. These rules primarily focus on preventing petroleum hydrocarbon releases to the environment from occurring. These rules also have provisions that require the responsible party to remediate petroleum hydrocarbon releases to the environment.

In the field of petroleum hydrocarbon remediation from soil, there are two basic approaches: applying a treatment technique to soil in place (in-situ), or applying a treatment technique to excavated soil (ex-situ). There are advantages and disadvantages for each approach and the selection of the approach is based on the site-specific circumstances of each petroleum hydrocarbon release.

Ex-situ thermal desorption technologies can include techniques that involve mechanical agitation of the soil during the heating process, which involve mechanical agitation and operate in a continuous process where the soil is continuously introduced to the process and is mechanically moved through the process apparatus until treatment is complete, and then is continuously discharged to a container for disposal or re-use.

Alternately, the soil can be treated in a static configuration, in which a given amount of soil is introduced to the treatment chamber. The soil configurations can include pile arrangement and container arrangements.

Nearly all the prior art processes use combustion of fossil fuel as a heat source. This can have the undesirable consequence of forming products of incomplete combustion, oxides of nitrogen, and other greenhouse gases as a by-product. Combustion also has the potential to add unburned hydrocarbons to the process exhaust gas if strict control of the combustion process is not maintained.

There can a need for an ex-situ static process that is labor, time and energy efficient in the treatment process, and is environmentally friendly.

### SUMMARY

A thermal desorption process can be used to treat contaminated soil in static arrangement, which is inherently safe, for example, due to the absence of open flame heating.

In some embodiments, systems and methods are provided for treating an immediate exhaust of a thermal desorption chamber, for example, to improve the safety of the treatment process, such as reducing potential explosion or flammability when treating highly contaminated soil.

In some embodiments, systems and methods are provided to monitor a temperature of the exhaust gas of the thermal desorption chamber. If this temperature is below an auto-ignition temperature of the contaminants in the soil, explosion hazard can be reduced or prevented. In some embodiments, this temperature can be used to control a thermal energy input to the thermal desorption chamber, for example, to regulate a heater that heats the treatment gas to limit the exhaust temperature to below the auto-ignition temperature. The contaminants can include different types of hydrocarbons with different auto-ignition temperature, so a reasonable upper end temperature of 500 F (260 C) or 400 F (204 C) can be used to limit the temperature of the exhaust gas.

In some embodiments, systems and methods are provided to monitor a hydrocarbon concentration of the exhaust gas of the thermal desorption chamber. If this concentration is outside the range of flammability of the hydrocarbons, explosion hazard can be reduced or prevented. In some embodiments, this concentration can be used to control an input flow rate of the treatment gas to the thermal desorption chamber, for example, to regulate, e.g., by increasing or decreasing, the treatment gas to confine the exhaust concentration to outside the flammability range. The contaminants can include different types of hydrocarbons with different flammability range, so a reasonable range between 5 vol % and 15-30 vol %, such as between 5 vol % and 25 vol % or between 5 vol % and 20 vol %, can be used.

In some embodiments, systems and methods are provided to direct flame propagation and explosion fronts to a relief chimney to prevent damage to property and personnel. An isolation valve and a pressure relief chimney can be coupled to the exhaust of the thermal desorption chamber. The isolation valve can be configured to sense flame propagation and explosion fronts, and can be closed. A pressure relief valve can be open to guide the flame propagation and explosion fronts to a safe exhaust.

In some embodiments, systems and methods are provided to cool the exhaust gas of the thermal desorption chamber, for example, to a temperature below an auto-ignition temperature of the contaminants in the exhaust gas. The exhaust gas, when exiting the thermal desorption chamber, can be in the range of 1000 F (538 C). The exhaust gas can be cooled to a temperature of below 500 F (260 C) or 400 F (204 C) before being admitted to an exhaust gas treatment, for example, a heat exchanger to recover the hydrocarbon contaminants.

A cooling jacket, for example, using circulated coolant to regulate the temperature, can be used to reduce the temperature of the exhaust gas exiting the thermal desorption chamber. Alternatively, or additionally, cooling gas, such as fresh air from the ambient, can be provided to the exhaust gas stream. Cooling liquid, such as room temperature water, can be misted, e.g., fine droplet spraying, in the exhaust stream. Cryogenic liquid can also be used to decrease temperatures within the gas exhaust stream.

In some embodiments, systems and methods are provided to restrict the mean free paths of the exhaust gas exiting the thermal desorption chamber, for example, to limit the flame propagation and explosion fronts. A section of the gas exhaust conduit from the thermal desorption chamber can be filled with a porous media, which can assist in reducing or eliminating the potential explosion hazard in the conduit. The sizes of the conduit and the porous media can be designed to provide adequate flow conductance of the exhaust gas from the thermal desorption chamber to the treatment section.

### BRIEF DESCRIPTION OF THE DRAWINGS

FIG. 1 illustrates a schematic evaporative desorption system according to some embodiments.

FIG. 2 illustrates a thermal desorption chamber according to some embodiments.

FIGS. 3A-3C illustrate flowcharts for thermal desorption processes according to some embodiments.

FIG. 4 illustrates a thermal desorption chamber according to some embodiments.

FIGS. 5A-5C illustrate flowcharts for thermal desorption processes according to some embodiments.

FIGS. 6A-6C illustrate a downstream exhaust for a thermal desorption process according to some embodiments.

FIGS. 7A-7D illustrate different configurations for a downstream exhaust for a thermal desorption process according to some embodiments.

FIG. 8A-8B illustrate flow charts for operating isolation and relief valves according to some embodiments.

FIG. 9 illustrates a configuration for an exhaust line according to some embodiments.

FIGS. 10A-10B illustrate flow charts for operating isolation and relief valves according to some embodiments.

FIGS. 11A-11B illustrate configurations for an exhaust line according to some embodiments.

### DETAILED DESCRIPTION

In some embodiments, the invention relates to a process and apparatus for non-combustive thermal desorption of volatile contaminates from contaminated earth. The earth may include tar sand, oil sand, oil shale, bitumen, pond sediment, and tank bottom sediment. The concentration of the contaminates can be low concentration, e.g., less than about 3%, or high concentration, e.g., greater than about 3%. The process can provide cracking of the contaminates, and/or reclaiming condensable contaminates, then oxidizing and treating the non-condensable reclamation effluent, which can be recycled for use as the thermal desorption treatment gas.

The non-combustive thermal desorption of volatile contaminates from low concentration contaminated earth is described in U.S. Pat. No. 6,829,844 (Brady et al) which is incorporated herein by reference in its entirety. The thermal desorption can remove organic contamination from porous media such as soil, rock, clays or other porous media with low organic contamination (e.g., less than 3% organic contamination) where desiccated electrically heated atmospheric air is used as the primary treatment gas. High organic contamination (e.g., greater than 3%) can use an inert or low oxygen (<9 vol % oxygen) treatment gas to minimize or prevent explosions, at the expense of longer processing times as well as larger capacity downstream air handling and treatment equipment.

In some embodiments, disclosed are systems and methods for treating contaminated soil in practically all levels of organic contaminations at high throughput without the need for low oxygen content treatment gas. A safe conveyance of the treated vapor between the treatment chamber and the downstream processing equipment can be implemented to reduce the explosion hazards.

For example, the oxidation reaction occurring within the soil bed can consume most if not all of the oxygen within the treatment gas throughout most of the treatment cycle. Thus the treatment chamber can be inherently safe, even with the use of high oxygen concentration treatment gas, such as atmospheric air having oxygen concentration of 21%, to accelerate the treatment time and reduce downstream vapor processing equipment.

In some embodiments, disclosed are systems and methods to provide safe conveyance at the end of the treatment cycle, e.g., after the treatment gas leaves the soil box, since the hydrocarbon concentration within the soil bed significantly diminishes, and oxygen not consumed in the hydrocarbon oxidation can create an explosive mixture of hydrocarbon vapor and oxygen.

In some embodiments, the temperature of the treatment gas when leaving the treatment chamber can be regulated to reduce or eliminate the potential hazard of auto-ignition. Alternatively, the section of the conduit that is immediately adjacent to the treatment chamber that can experience high temperature can be proofed against explosion, such as having isolation and pressure relief chimney, cooling assembly to lower the temperature of the exhaust gas to below the auto-ignition temperature, and providing a porous flow condition to limit the propagation of flame or explosion fronts.

In some embodiments, the present invention, an evaporative desorption and/or reclamation process, can be cost effectively constructed to any scale and can exceed the 10 ton per hour production rate of indirect rotary kilns. The method can use non combustive heat in the treatment chamber, and rely on hot air moving through a static volume of porous media. The method can provide uniform heating of the soil/porous media with no mixing mechanisms for the porous media required for treatment. The process can provide efficient heat transfer to the soil/porous media, and can provide ancillary heat to heat the soil/porous media through an oxidation reaction that takes place within the soil/porous media, for example, through hydrocarbon cracking that takes place within the crude oil contaminated soil. In addition the process can recycle its heated treatment gas supply, minimizing energy required for treatment.

In some embodiments, the invention relates to a process and apparatus for thermal desorption of contaminates from a mixture of soil and rocks using non-combustion-heated fresh treatment gas, such as air, to treat the soil and rocks which have been excavated and placed in a thermally conductive treatment container which is then placed in a thermally insulated treatment chamber. The gas can be desiccated, e.g., having low humidity levels such as below 40, 30, 20, 10 or even below 5% relative humidity. The fresh, hot, desiccated air is drawn through the soil treatment container, cooled, and released; or discharged to a treatment system, as required or needed, prior to release to the atmosphere.

In some embodiments, a thermal desorption technique applied to a static configuration of contaminated soil using a container arrangement is provided. The thermal desorption technique can restore the soil to its un-contaminated condition by removing the contamination within the soil through the evaporative desorption process. To provide an efficient remediation process, different temperature settings can be used to treat different contaminated soil, and thus sample of the contaminated soil can be tested to determine appropriate treatment conditions.

The treatment process for thermal desorption of hydrocarbon contaminants from excavated soil provides efficient contaminant removal by handling the soil in a thermally conductive soil box that is contained in an insulated treatment chamber for treatment. The soil is treated with dry hot air to remove contaminants, and the decontaminated soil can be returned to the ground.

In some embodiments, systems and methods are provided to supply thermal desorption of high-concentration hydrocarbon contaminants from excavated soil, such as tar sand, oil sand, oil shale, bitumen, pond sediment, and tank bottom sediment. The systems can provide efficient contaminant removal by handling the soil in a thermally conductive soil box that fits within an insulated treatment chamber. The soil is treated in this chamber with hot dry treatment gas. The contaminates can be reclaimed from the soil box. A portion of the contaminates, such a non-condensable hydrocarbon contaminates, can be used for effluent conditioning, for example, to maintain a desired treatment gas temperature in the soil box.

Contaminated earth (soil and rocks or other earthy material) that has been excavated is placed in a thermally conductive soil box which is then placed in a thermally insulated treatment chamber. Heated treatment gases can be introduced to the soil box and flow through the soil box and the contaminated earth. Hot gas extraction, e.g., treatment gases containing contaminates, can be withdrawn from the treatment chamber. The process is continued until the contaminates are completely removed from the soil, e.g., below a desired contamination level.

In some embodiments, the contaminates can be reclaimed from the hot gas extraction, for example, through a heat exchanger to cool and separate the condensable contaminates. The remaining hot gas extraction can be treated in a combustion or electrically heated thermal oxidizer, for example, to remove non-condensable contaminates. The output from the thermal oxidizer can be partially recycled to the treatment chamber as the treatment gas, or to maintain the temperature of the treatment chamber.

The soil box can have sides to contain the contaminated soil. For example, the soil box can be an open top rectangular cube, prism or cylinder. The soil box can also have a gas exit pathway within the contaminated soil so that gases in the contaminated soil flow to the gas exit pathway.

The treatment chamber can have an opening so the soil box may be inserted or removed, a gas inlet to receive hot dry gas, which can be directed to the soil box, and a gas outlet arranged to be mated with the gas exit pathway of the soil box so the gases in the contaminated soil exit the treatment chamber.

A heater and drier assembly can be arranged so that the incoming treatment gas to the treatment chamber is dried and heated upon entering the treatment chamber. A blower assembly can be arranged to direct the hot gas extraction from the soil box to exit the treatment chamber.

Dry, heated incoming treatment gas can be provided to the soil box, for example, to the opening of the soil box and/or to the sides of the soil box, to transferring heat to the contaminated soil, inducing the migration of contaminates through the soil to the gas exit pathway. The heated treatment gas flows through the contaminated soil, directly heating the soil before entering the gas exit pathway and exiting the chamber, carrying the contaminates.

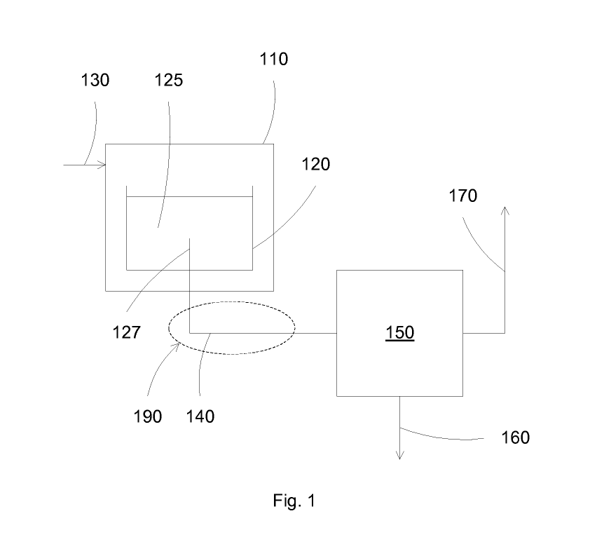

FIG. 1 illustrates a schematic evaporative desorption system according to some embodiments. One or more soil boxes 120 can be placed in a treatment chamber 110. The treatment chamber can be insulated to prevent heat loss. The soil boxes can be open on top and contain a gas exit pathway 127. The soil boxes, after filled with contaminated soil 125, can be installed in the treatment chamber 110 for contamination treatment, and can be removed after the contamination treatment is complete. The soil boxes can provide for a batch process for contaminated soil and clean soil. Hot and dry treatment gas 130 can be introduced to the treatment chamber 110. The treatment gas can pass through the contaminated soil in the soil box to the gas exit pathway 127 coupled to the treatment chamber exhaust 140, and then flow out of the treatment chamber 110. In some embodiments, the treatment gas can have controlled humidity for optimizing the treatment process. For example, a wet soil can accept a low humidity treatment gas, e.g., dry gas, while a dry soil can accept higher humidity treatment gas, e.g., wetter gas.

The exhausted treatment gas can contain hydrocarbon contaminates, which can be recovered. A recovering assembly 150 can be coupled to the treatment chamber exhaust 140 to recover all or a portion of the hydrocarbons in the exhaust treatment gas. The recovering assembly 150 can include one or more heat exchangers and a gas extraction fan, which provides the flow of treatment gas from the treatment chamber 110 through the heat exchangers. The contaminates can be condensed and flow to a phase separator to recover the condensate from heat exchangers. Heavy organics, light organics, and water can be separated in the phase separator and flow 160 through the outlets to collection tanks. Remaining residues can be exhausted 170 to a vent stack.

In some embodiments, a thermal desorption process with improved safety are provided. At temperatures below the auto-ignition temperature of hydrocarbons (which is about 400 F for hydrocarbon chains n-CₓH_{y} having x>8, and about 500 F for x>5), the conveyance of the exhaust gas, which is the treatment gas carrying the hydrocarbon contaminants, can have minimum explosion hazard. Thus in some embodiments, special considerations are provided in the conduit section 190 until the exhaust gas temperature is reduced to below the auto-ignition temperature. Alternatively, the exhaust gas temperature can be limited to below the auto-ignition temperature as soon as it exits the thermal desorption chamber.

In some embodiments, systems and methods are provided to regulate a temperature of the exhaust gas of the thermal desorption chamber to reduce or prevent potential explosion hazards. A temperature measurement device, such as a thermocouple, can be placed at or near the exhaust line of the thermal desorption chamber to measure the temperature of the treatment gas that exits the chamber. The measured temperature can be used to control a thermal energy input to the thermal desorption chamber, for example, by regulating a heater that heats the treatment gas. The contaminants can include different types of hydrocarbons with different auto-ignition temperature, so a reasonable upper end temperature of 500 F (260 C) or 400 F (204 C) can be used to limit the temperature of the exhaust gas.

In some embodiments, input temperature regulation can be reflected in the treatment gas exit temperature. For example, inlet heaters can be used to heat the treatment gas. The inlet heaters can be controlled through a variable frequency drive assembly that will automatically adjust heat delivery based on a temperature feedback from the exhaust gas. Limiting the temperature of the exhaust gas to, for example, 400 F will reduce the temperature below an auto ignition temperature. Bench studies show significant hydrocarbon vapor production with treatment gas exit temperature of 400 F. Redundant thermocouples placed at the soil box exit can be the set point temperature setting.

Within the soil bed, temperatures will exceed 400 F. However, the treatment gases are contained within the soil and subsequently cooled between the moving oxidation front and the soil box exit. The vapors are in porous flow conditions, which acts similar to a spark or flame arrestor. The vapor pathways are non-linear, which will not propagate a spark or flame.

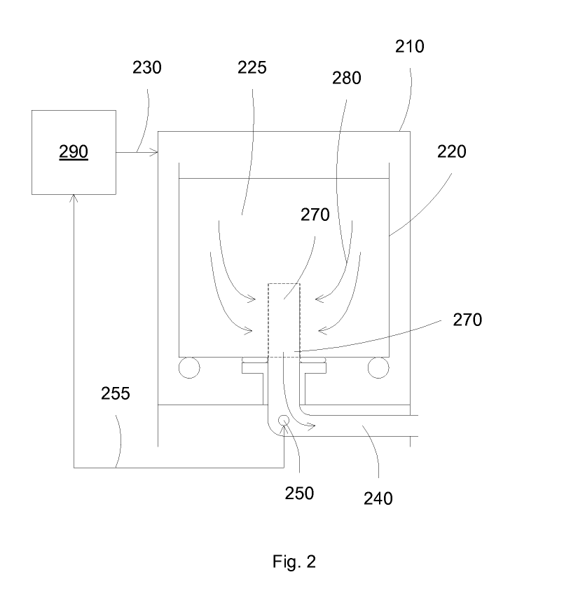

FIG. 2 illustrates a thermal desorption chamber according to some embodiments. The soil box 220 is a removable, sometimes called a roll-off, hopper modified to contain the gas exit pathway 270. The open-top soil box 220 can be supported by rollers or steel rails (not shown) in the bottom. The treatment chamber 210 can accept a hot and dry treatment gas 230, such as desiccated air. The treatment gas can enter the soil 225, flow 280 toward the gas exit pathway 270, carrying away the contaminants within the soil to the exhaust line 240. The treatment chamber 210 can be thermal insulated. The soil box 220 contains a gas exit pathway 270 located near the bottom of the soil box. The gas exit pathway can be perforated to allow flow of treatment gas from the surrounding soil into the pathway. The soil box 220 can be installed on a pedestal soil box support that provides a flow path from the soil box gas exit pathway 270 to provide for treatment gas and contaminants from the treatment chamber to exit 240 the chamber.

A thermocouple 250 can be placed in the exhaust line 240, such as at or near the exit at the thermal desorption chamber 210. A feedback 255 can be provided to a heater/blower assembly 290, which is configured to provide the dry hot treatment gas 230 to the thermal desorption chamber 210. The feedback 255 can be used to regulate, e.g., increasing or decreasing, a thermal energy provided to heat the treatment gas input 230. For example, at the beginning of a treatment cycle, the exhaust temperature at the thermocouple 250 can be low, and a heater in the heater/blower assembly 290 can be turned on to heat the treatment gas 230. When the exhaust temperature exceeds a set point, such as an auto-ignition temperature of the hydrocarbon contaminants, the heater power can be reduced or turned off. The auto-ignition temperature can be pre-determined before the treatment, for example, by assessing the characteristics of the contaminated foil through a sample run. Alternatively, a pre-determined temperature of 400 F or 500 F can be used.

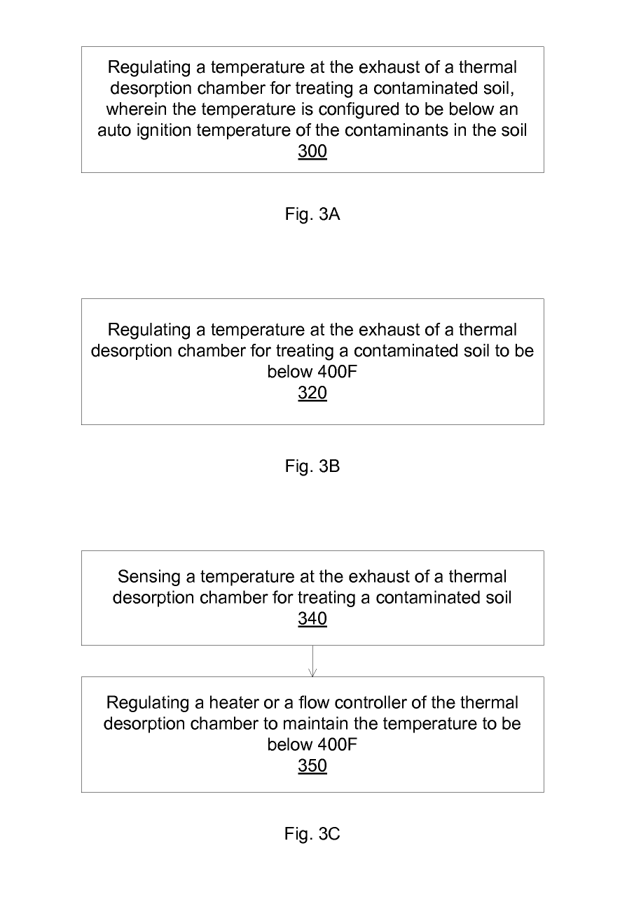

FIGS. 3A-3C illustrate flowcharts for thermal desorption processes according to some embodiments. In FIG. 3A, operation 300 regulates a temperature at the exhaust of a thermal desorption chamber for treating a contaminated soil, wherein the temperature is configured to be below an auto ignition temperature of the contaminants in the soil. In FIG. 3B, operation 320 regulates a temperature at the exhaust of a thermal desorption chamber for treating a contaminated soil to be below 400 F (204 C) or 500 F (260 C). In FIG. 3C, operation 340 senses a temperature at the exhaust of a thermal desorption chamber for treating a contaminated soil. Operation 350 regulates a heater or a flow controller of the thermal desorption chamber to maintain the temperature to be below 400 F or 500 F.

In some embodiments, systems and methods are provided to provide a safe conveyance of potential explosive vapors from the treatment chamber, e.g., the soil box to the exhaust gas treatment equipment, e.g., a heat exchanger. The safe transport of hydrocarbon vapors, while maintaining a fast treatment cycle of the evaporative desorption process, especially for high level contaminated soil, can include keeping the treatment gases below auto ignition temperature, maintaining porous flow, rapid cooling, maintaining cool chase way skin temperatures and isolating critical sections of the conveyance assembly. The safe conveyance can treat hydrocarbon contaminants with high concentration, for example, up to 30% and higher, and can recover liquid cracked crude oil.

In some embodiments, systems and methods are provided to regulate a hydrocarbon concentration of the exhaust gas of the thermal desorption chamber to be outside the range of flammability of the hydrocarbons. An input flow of the treatment gas, such as air, to the thermal desorption chamber can be adjusted in a controlled manner to maintain the exhaust gas in a condition that is outside the flammable mixture concentration envelope for the contaminates of interest. The contaminants can include different types of hydrocarbons with different flammability range, so the treatment gas flow can be maintained between 5 vol % and 15-30 vol %, such as between 5 vol % and 25 vol % or between 5 vol % and 20 vol %, depending on the soil conditions.

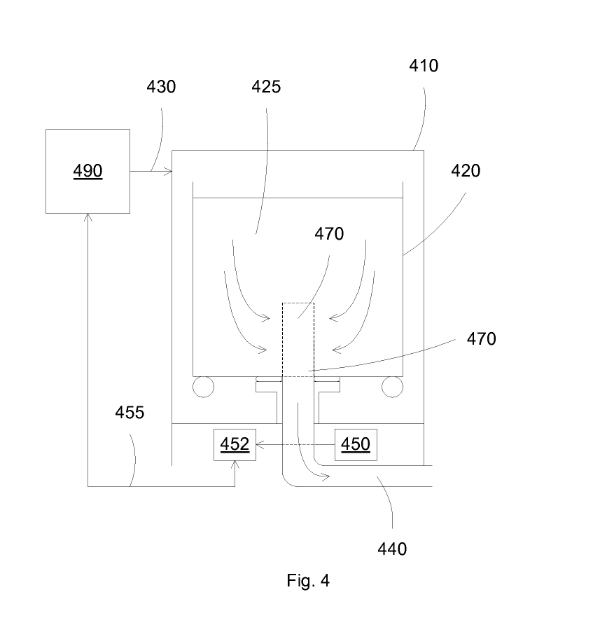

FIG. 4 illustrates a thermal desorption chamber according to some embodiments. The soil box 420 is a removable hopper modified to contain the gas exit pathway 470. The treatment chamber 410 can accept a hot and dry treatment gas 430, such as desiccated air. The treatment gas can enter the soil 425, flow 480 toward the gas exit pathway 470, carrying away the contaminants within the soil to the exhaust line 440. The soil box 420 can be installed on a pedestal soil box support that provides a flow path from the soil box gas exit pathway 470 to provide for treatment gas and contaminants from the treatment chamber to exit 440 the chamber.

A concentration measurement device 450/452, such as a laser assembly, can be placed in the exhaust line 440, such as at or near the exit at the thermal desorption chamber 410. For example, a laser 450 can send a laser beam across the exhaust flow. An intensity measurement device 452 can receive the signal from the laser 450. If the laser 450 is tuned to the hydrocarbon species in the exhaust flow, a portion of the laser beam can be absorbed or scattered due to the presence of the hydrocarbons. Thus the measured intensity signal at device 452 can indicate a concentration of the hydrocarbons in the exhaust flow. A feedback 455 can be provided to a heater/blower assembly 490, which is configured to provide the dry hot treatment gas 430 to the thermal desorption chamber 410. The feedback 455 can be used to regulate, e.g., increasing or decreasing, a thermal energy provided to heat the treatment gas input 430. For example, if the measured hydrocarbon concentration is lower than a flammable limit, e.g., 20, 25 or 30 vol % concentration of hydrocarbons in the treatment gas flow stream, a lower flow rate of the treatment gas 430 can be provided to increase the concentration to be outside the flammability range. Similarly, if the measured hydrocarbon concentration is higher than a flammable limit, e.g., 5 vol % concentration of hydrocarbons in the treatment gas flow stream, a higher flow rate of the treatment gas 430 can be provided to lower the concentration to be outside the flammability range.

In some embodiments, a combination of temperature and concentration monitoring can be used to regulate the exhaust from the treatment chamber.

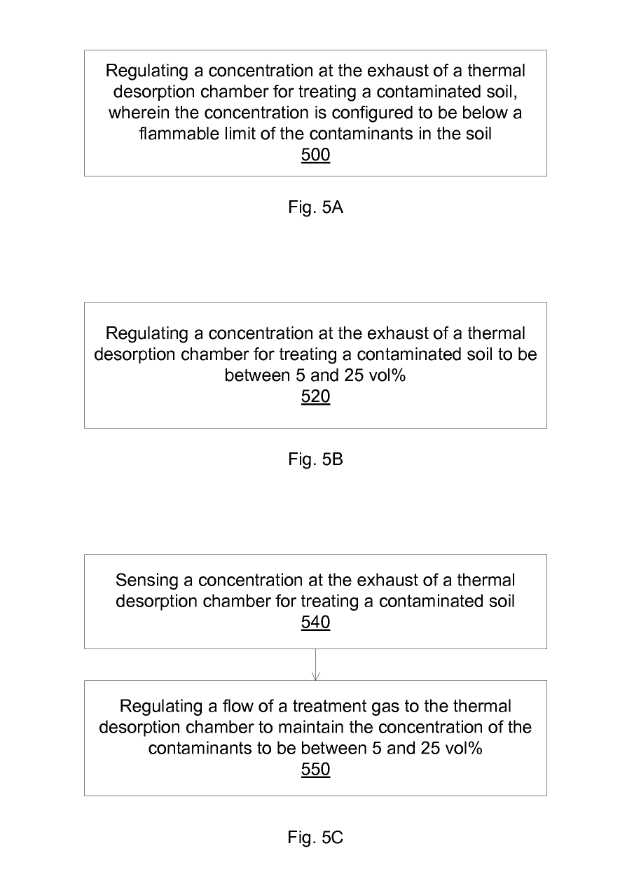

FIGS. 5A-5C illustrate flowcharts for thermal desorption processes according to some embodiments. In FIG. 5A, operation 500 regulates a concentration at the exhaust of a thermal desorption chamber for treating a contaminated soil, wherein the concentration is configured to be below a flammable limit of the contaminants in the soil. In FIG. 5B, operation 520 regulates a concentration at the exhaust of a thermal desorption chamber for treating a contaminated soil to be between 5 and 25 vol %, between 5 and 20 vol %, or between 5 and 15 vol %. In FIG. 5C, operation 540 senses a concentration at the exhaust of a thermal desorption chamber for treating a contaminated soil. Operation 550 regulates a flow of a treatment gas to the thermal desorption chamber to maintain the concentration of the contaminants to be between 5 and 25 vol %, between 5 and 20 vol %, or between 5 and 15 vol %.

In some embodiments, systems and methods are provided to prevent damage to property and personnel, for example, by directing flame propagation and explosion fronts to a relief chimney. The soil box itself can act as an explosion arrestor due to the porous media and mass, and therefore can be inherently safe from explosion hazard. The conveyance from the exit of the thermal desorption chamber to the heat exchanger can have isolation and venting capabilities to handle a potential conflagration event. The downstream portion of the conveyance can have a passive isolation valve just before the vapor treatment system. The passive isolation valve can be open during normal operations and close during a conflagration event. For example, the isolation valve can be configured to close when sensing flame propagation and explosion fronts. The isolation valve, when closed, can stop the explosion fronts from propagating to the downstream equipment. In addition, a pressure relief valve can be provided before the isolation valve. For example, immediately before the passive isolation valve, the conveyance can be equipped with a rupture disc and vent system that directs any potential explosion upwards in a safe direction. The pressure relief valve can be configured to open when the isolation valve is close to guide the flame propagation and explosion fronts to a safe exhaust. The conveyance is constructed with durable steel to withstand potential conflagration events.

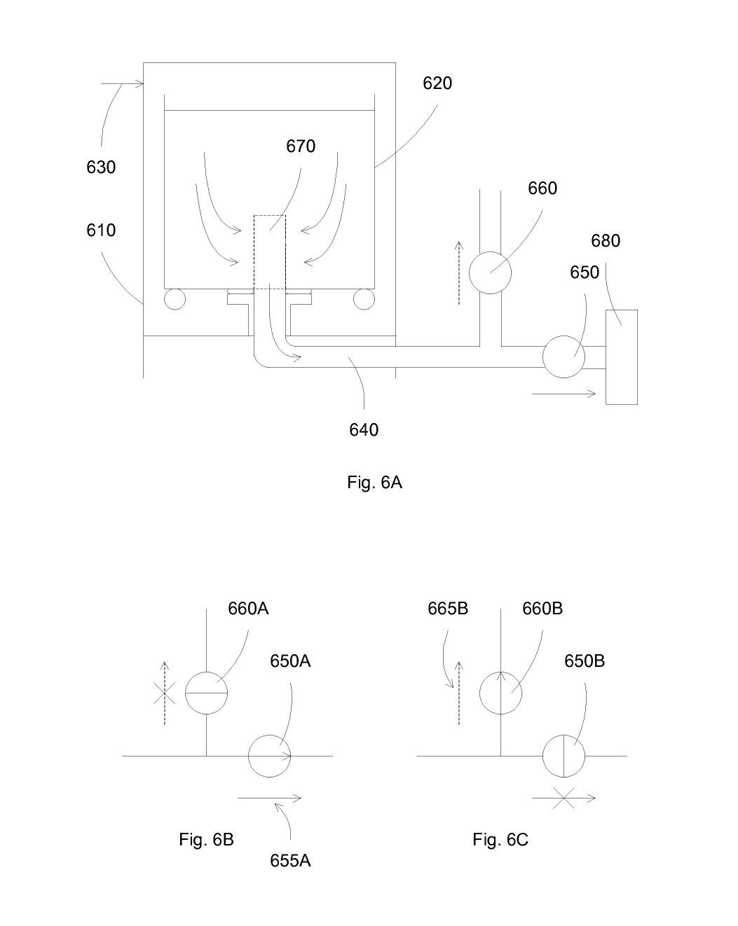

FIGS. 6A-6C illustrate a downstream exhaust for a thermal desorption process according to some embodiments. A soil box 620 is a removable container having a gas exit pathway 670. The treatment chamber 610 can accept a hot and dry treatment gas 630, such as desiccated air. The treatment gas can enter the soil, flow toward the gas exit pathway 670, carrying away the contaminants within the soil to the exhaust line 640.

An isolation valve 650 is placed after the exhaust line 640. The isolation valve can be placed before an exhaust gas treatment assembly, such as a heat exchanger 680 for recovering condensable hydrocarbon contaminants within the exhaust gas. The isolation valve is normally open, e.g., allowing the exhaust gas to flow through the exhaust line 640 to the heat exchanger 680. A pressure relieve valve 660 can be placed before the isolation valve 650. The pressure relieve valve is normally close, e.g., allowing the exhaust gas to flow through the exhaust line 640 to the heat exchanger 680. The pressure relief valve 660 is coupled to a chimney configured to safely discharge the exhaust gas.

In some embodiments, the temperature of the exhaust gas can be reduced to below an auto-ignition temperature, e.g., below 400 F or below 500 F, at the location of the isolation valve 650. For example, the exhaust gas, when exiting the thermal desorption chamber 610, can be about 1000 F. The high temperature of the exhaust gas can be the result of a hot treatment gas 630, which can be at 1000 F or above. The high temperature of the treatment gas 630 can allow a fast treatment of the soil in the treatment chamber 610. After the isolation valve, the temperature of the exhaust gas is below an auto-ignition temperature of the hydrocarbon contaminants, thus can reduce or eliminate explosion hazard at downstream equipment, such as at the heat exchanger 680 or any equipment further downstream of the exhaust gas.

Since the section of the conduit 640 from the exit of treatment chamber 610 to the isolation valve can have a high temperature exhaust gas, e.g., above the auto-ignition temperature, there can be explosion hazard. A combination of the isolation valve 650 and the pressure relief valve 660 can safely handle the explosion, protecting the downstream equipment such as the heat exchanger 680 and preventing possible damage to personnel or equipment. The conduit 640 can be made of explosion proof materials, such as durable steel, to withstand explosion.

FIG. 6B shows a configuration of the isolation valve and the pressure relief valve during the normal operation of the thermal desorption process. The isolation valve is in open position 650A and the pressure relief valve is in close position 660A. The exhaust gas can flow 655A through the isolation valve to a heat exchanger for treating the exhaust gas. FIG. 6C shows a configuration of the isolation valve and the pressure relief valve during an explosion of the thermal desorption process. Sensing the explosion, the isolation valve can be in close position 650B and the pressure relief valve is in open position 660B. The explosion can flow 665B upward, through the pressure relief valve to a chimney for safely discharge.

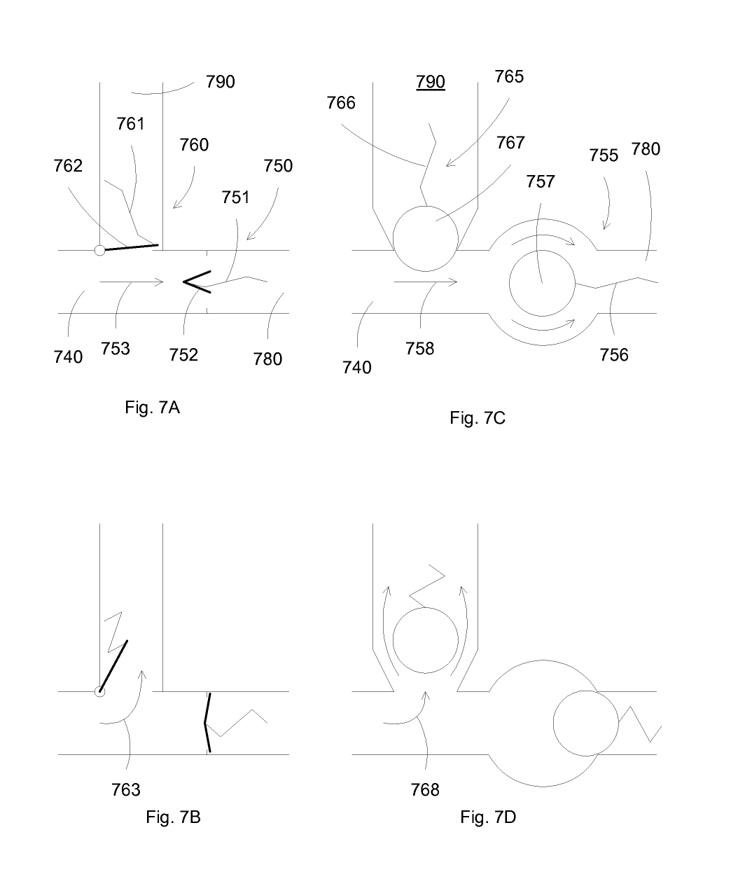

FIGS. 7A-7D illustrate different configurations for a downstream exhaust for a thermal desorption process according to some embodiments. FIG. 7A shows a normal operation and FIG. 7B shows an explosion scenario for a downstream exhaust configuration. An isolation valve 750 is placed between an exit exhaust line 740 from the thermal desorption chamber and a downstream line 780 such as a heat exchanger. The isolation valve 750 can include a flap 752 coupled to a spring 751. The isolation valve 750 is normally open to allow the exhaust gas to flow 753 from the thermal desorption chamber to the heat exchanger. A pressure relief valve 760 can be placed before the isolation valve 750. The pressure relief valve 760 can include a flap 762 coupled to a spring 761. The pressure relief valve 760 is normally open to block the path 790 to a chimney exhaust.

When an explosion or a gas burning occurs, the pressure in the exhaust line 740 can be increased, for example, due to the rapid expansion of the explosion pressure fronts. The explosion pressure fronts can exert pressure on the flap 752, compressing the spring 751 and blocking the downstream path 780 to the heat exchanger. At the same time, the explosion fronts can also exert pressure on the flap 762, compressing the spring 761 and open the path 790 to the chimney exhaust, which can safely divert the explosion 763 to the chimney.

After the explosion is subdued, for example, by some safety mechanism to reduce or eliminate the flammability of the gas exhaust, the springs 751 and 761 can relax from their compressed states, which can bring the isolation valve 750 and the pressure relief valve 760 back to the normal operation configuration.

FIG. 7C shows a normal operation and FIG. 7D shows an explosion scenario for another downstream exhaust configuration. An isolation valve 755 is placed between an exit exhaust line 740 from the thermal desorption chamber and a downstream line 780 such as a heat exchanger. The isolation valve 755 can include a ball 757 coupled to a spring 756. When the spring 756 is in its relaxed state, the ball 757 is pushed forward, allowing the exhaust gas to flow 758 around the ball 757 from the exhaust line 740 of the thermal desorption chamber to the inlet line 780 to the heat exchanger. A pressure relief valve 765 can be placed before the isolation valve 755. The pressure relief valve 760 can include a ball 767 coupled to a spring 766. When the spring 766 is in its relaxed state, the ball 757 is pushed forward, blocking the path 790 to a chimney exhaust.

When an explosion or a gas burning occurs, the pressure in the exhaust line 740 can be increased, for example, due to the rapid expansion of the explosion pressure fronts. The explosion pressure fronts can exert pressure on the ball 757, compressing the spring 756 and blocking the downstream path 780 to the heat exchanger. At the same time, the explosion fronts can also exert pressure on the ball 767, compressing the spring 766 and open the path 790 to the chimney exhaust, which can safely divert the explosion 768 to the chimney.

After the explosion is subdued, the springs 756 and 766 can relax from their compressed states, which can bring the isolation valve 755 and the pressure relief valve 765 back to the normal operation configuration.

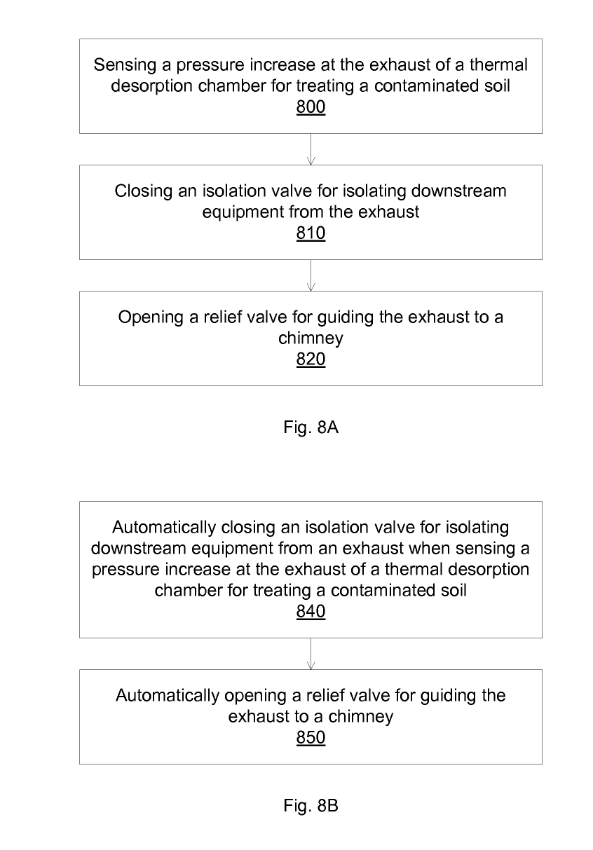

FIG. 8A-8B illustrate flow charts for operating isolation and relief valves according to some embodiments. In FIG. 8A, operation 800 senses a pressure increase at the exhaust of a thermal desorption chamber for treating a contaminated soil. Operation 810 closes an isolation valve for isolating downstream equipment from the exhaust. Operation 820 opens a relief valve for guiding the exhaust to a chimney.

In FIG. 8B, operation 840 automatically closes an isolation valve for isolating downstream equipment from an exhaust when sensing a pressure increase at the exhaust of a thermal desorption chamber for treating a contaminated soil. Operation 850 automatically opens a relief valve for guiding the exhaust to a chimney.

In some embodiments, systems and methods are provided to cool the exhaust gas of the thermal desorption chamber, for example, to a temperature below an auto-ignition temperature of the contaminants in the exhaust gas. For example, an exhaust line section can be placed between the thermal desorption chamber and the exhaust gas treatment equipment. The exhaust line section can accept an input exhaust gas having high temperature, e.g., about 1000 F, and provide an output exhaust gas having lower temperature, e.g., below an auto-ignition temperature of the contaminants in the exhaust gas such as 400 F or 500 F. The exhaust gas, when exiting the thermal desorption chamber, can be in the range of 1000 F (538 C). The exhaust gas can be cooled to a temperature of below 500 F (260 C) or 400 F (204 C) before being admitted to an exhaust gas treatment, for example, a heat exchanger to recover the hydrocarbon contaminants.

By providing an exhaust line section that can cool the exhaust gas, explosion proof design can be confined to the exhaust line portion, without extending to portions of the thermal desorption process. Also, by providing a high exhaust temperature at the exit of the thermal desorption chamber, higher throughput, efficiency, and simpler chamber designs can be accomplished.

In some embodiments, the exhaust line section can be jacketed with cooling fluid to reduce internal skin temperatures below an auto ignition temperature. The cooling fluid can be routed to a cooling radiator similar to an automobile engine. The temperature of the exhaust gas can be reduced through cooling gas, such as fresh air or nitrogen, or through water misting, e.g., fine droplet spraying, in the exhaust stream or injection of a cryogenic fluid into the vapor stream. The water misting can be aerated with nitrogen. The temperature control of the exhaust line section can provide a safe transport of hazardous vapors.

The exhaust cooling system cooler may provide cooling of the contaminated hot gas exiting the treatment chamber by employing injection of cool air rather than using the water injection. This can add volume to the amount of exhaust gas to be processed, requiring a larger gas extraction blower and increased off-gas processing capacity, if a post-exhaust off-gas processing system is used.

The exhaust cooling system may have water-injection provided from a separate, atmospheric pressure, water tank, or source of pressurized water. If this method is used, the water is drawn through the water-injection pipe, to the exit penetration of the gas exit pathway by the vacuum in the gas exit pathway during operation of the gas extraction blower. The cooler still requires a reservoir for water that has not vaporized and will require periodic draining between soil treatments.

The exhaust cooling system cooler may provide cooling of the contaminated hot gas exiting the treatment chamber by employing a heat exchanger rather than using a water injection system. This can add components to the treatment process, and requires a continuous flow of coolant during treatment of a batch of contaminated soil, increasing costs. The coolant may also be a refrigeration system. This system uses the heat exchanger as the refrigeration cycle evaporator. This has the advantage of chilling the exhaust gases to a cold enough temperature, such as near or below freezing, that some contaminants, for example, polychlorinated biphenyls (PCBs), can be condensed in the cooler. The refrigeration cycle is typically a compressor taking suction from the discharge of the evaporator. The compressor discharge flows to a condenser where the pressurized, hot refrigerant is cooled. The pressurized, cool refrigerant is then depressurized by flowing through a restricted flow area on entry into the evaporator where it is available to absorb heat and then continue the cycle.

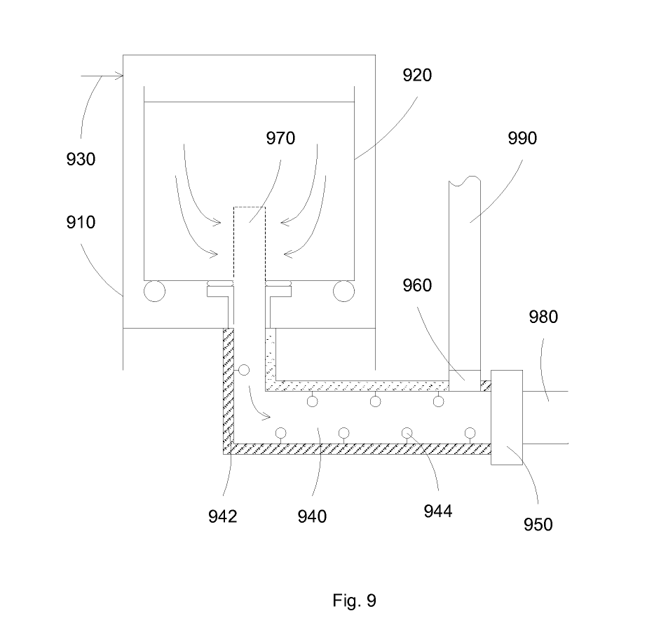

FIG. 9 illustrates a configuration for an exhaust line according to some embodiments. A soil box 920 is a removable container having a gas exit pathway 970. The treatment chamber 910 can accept a hot and dry treatment gas 930, such as desiccated air. The treatment gas can enter the soil, flow toward the gas exit pathway 970, carrying away the contaminants within the soil to the exhaust line 940.

An isolation valve 950 is placed after the exhaust line 940. The isolation valve can be placed before an exhaust gas treatment assembly, such as a heat exchanger inlet 980. A pressure relieve valve 960 can be placed before the isolation valve 950, providing pathway 990 to a chimney configured to safely discharge the explosive gas.

The exhaust line 940, which can be between the exit of the treatment chamber 910 and the isolation valve 950, are cooled, for example, by a heat dissipation cover 942. The heat dissipation cover 942 can be configured to reduce the temperature of the exhaust gas to be at or below an auto-ignition temperature of the hydrocarbon contaminants within the exhaust gas. For example, at the exit of the treatment chamber 910, e.g., the inlet of the exhaust line 940, the temperature of the exhaust gas can be about 1000 F, depending on the thermal desorption process which occurs in the treatment chamber 910. At the outlet of the exhaust line 940, e.g., before or after the isolation valve 950, the temperature of the exhaust gas can be about 400 F or 500 F, depending on the types of contaminated soils. The heat dissipation cover 942 can include heat fins for dissipating thermal energy of the heated exhaust gas in the exhaust line 940. The dissipation cover 942 can include active cooling assembly, such as a cooling jacket or cooling coils having circulated coolant for cooling the heated exhaust gas.

Further, nozzles 944 can be provided in the exhaust line 940 to introduce cooling gas or liquid, such as air flow, water misting or water aerated flow, to reduce the temperature of the exhaust gas. The nozzles 944 can be provided only at the inlet of the exhaust line 940. The nozzles 944 can be distributed along the exhaust line 940, either uniformly, or gradedly, for example, higher gas or liquid flow can be provided near the inlet of the exhaust line 940.

In some embodiments, the exhaust line 940 can be graded to allow condensed hydrocarbon to flow into the recovery tank. The exhaust line 940 can be graded toward the downstream portion 990 to allow condensed hydrocarbons to flow to the heat exchanger. The exhaust line 940 can be graded toward the inlet portion, together with a collection mechanism to recover the condensed hydrocarbons.

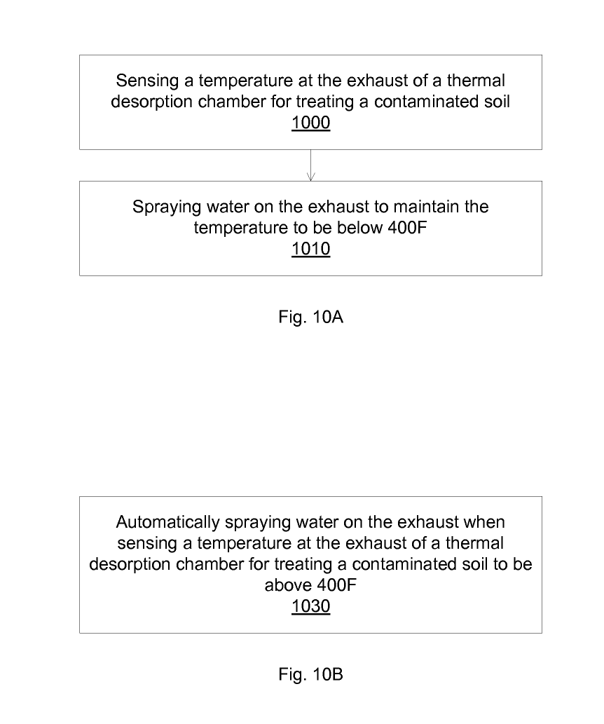

FIGS. 10A-10B illustrate flow charts for operating isolation and relief valves according to some embodiments. In FIG. 10A, operation 1000 senses a temperature at the exhaust of a thermal desorption chamber for treating a contaminated soil. Operation 1010 sprays water on the exhaust to maintain the temperature to be below 400 F.

In FIG. 10B, operation 1030 automatically sprays water on the exhaust when sensing a temperature at the exhaust of a thermal desorption chamber for treating a contaminated soil to be above 400 F.

In some embodiments, systems and methods are provided to restrict the mean free paths of the exhaust gas exiting the thermal desorption chamber, for example, to limit the flame propagation and explosion fronts. The mean free path of the exhaust gas flow can be less 10 mm, less than 5 mm, less than 2 mm, or less than 1 mm. The mean free path can be the average of the traveled distances of the gas molecules between collision. For example, the mean free path can be the average of the gaps between materials in the exhaust conduit. A section of the gas exhaust conduit from the thermal desorption chamber can be filled with a porous media, which can assist in reducing or eliminating the potential explosion hazard in the conduit. The sizes of the conduit and the porous media can be designed to provide adequate flow conductance of the exhaust gas from the thermal desorption chamber to the treatment section. For example, the cross sectional area of the exhaust line can be large enough to overcome the head loss associated with porous flow.

The exhaust line can also be equipped with a sump pump to continuously remove any condensed hydrocarbon. The recovered liquid hydrocarbon condensate can be pumped through a cooled line and transported to a recovery tank

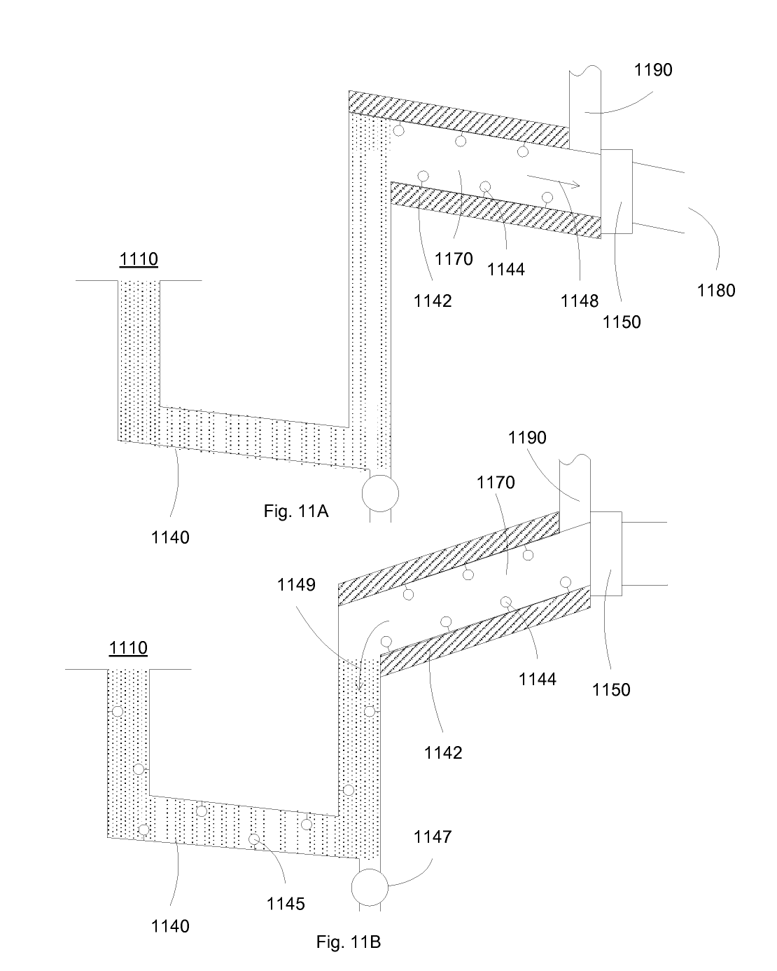

FIGS. 11A-11B illustrate configurations for an exhaust line according to some embodiments. An exhaust line 1140 is disposed between a thermal desorption chamber 1110 and an isolation valve 1150. The isolation valve can be placed before an exhaust gas treatment assembly, such as a heat exchanger inlet 1180. A pressure relieve valve can be placed before the isolation valve 1150, providing pathway 1190 to a chimney configured to safely discharge the explosive gas.

A heat dissipation cover 1142, together with nozzles 1144 for cooling the exhaust gas in a portion 1170 of the exhaust line, so that when the exhaust gas 1148 reaches the isolation valve 1150, the temperature of the exhaust gas is lower than an auto ignition temperature.

The portion of the exhaust line 1140, which can be between the exit of the treatment chamber 1110 and the line section 1170, can contain a porous material, for example, to limit the mean free path of the gas molecules, effectively reducing the chance of explosion. Optional nozzles 1145 can be provided at the porous material portion of the exhaust line for cooling the exhaust gas.

In some embodiments, the portion of the exhaust line 1140 and the section 1170 can be graded to allow condensed hydrocarbon to flow into a recovery tank. The section 1170 can be graded toward the downstream portion 1149 to allow condensed hydrocarbons to flow to the heat exchanger 1147. The section 1170 and portion of the exhaust line 1140 can be graded toward a recovery tank, together with a collection mechanism to recover the condensed hydrocarbons.

What is claimed is:

1. A method comprising
flowing a heated gas to a contaminated soil to generate an exhaust gas from the contaminated soil, wherein the contaminated soil comprises hydrocarbon contaminants;
restricting mean free paths of the exhaust gas to reduce a propagation of an explosion caused by the exhaust gas.

2. A method as in claim 1
wherein the restricted mean free paths is less than 5 mm.

3. A method as in claim 1 further comprising
regulating a temperature of the exhaust gas to be below an auto-ignition temperature of the hydrocarbon contaminants.

4. A method as in claim 1 further comprising
regulating the flow of the heated gas so that a concentration of the hydrocarbon contaminants is outside a range of flammability of the hydrocarbon contaminants.

5. A method as in claim 1 further comprising
isolating downstream equipment and directing the exhaust gas to a relief chimney during the explosion.

6. A method as in claim 1 further comprising
cooling the exhaust gas to be below an auto-ignition temperature of the hydrocarbon contaminants.

7. A method as in claim 1 further comprising
spraying water onto the exhaust gas to reduce a temperature of the exhaust gas.

8. A method comprising
forming a treatment chamber, wherein the treatment chamber is configured to contain a contaminated soil, wherein the contaminated soil comprises hydrocarbon contaminants, wherein the treatment chamber comprises an inlet configured for accepting a heated gas to the treatment chamber, wherein the treatment chamber comprises an outlet configured for output an exhaust gas from the contaminated soil;
forming an exhaust conduit coupled to the outlet;
supplying a porous material in the exhaust conduit for restricting mean free paths of the exhaust gas.

9. A method as in claim 8
wherein the restricted mean free paths is less than 2 mm.

10. A method as in claim 8 further comprising
forming a temperature measurement element in the exhaust conduit, wherein the temperature measurement element is coupled to the heated gas for regulating a temperature of the exhaust gas to be below an auto-ignition temperature of the hydrocarbon contaminants.

11. A method as in claim 8 further comprising
forming a hydrocarbon concentration measurement element in the exhaust conduit, wherein the hydrocarbon concentration measurement element is coupled to the heated gas for regulating a flow of the heated gas so that a concentration of the hydrocarbon contaminants is outside a range of flammability of the hydrocarbon contaminants.

12. A method as in claim 8 further comprising
forming an isolation valve for isolating downstream equipment;
forming a relief chimney for directing the exhaust gas to a relief chimney during an explosion caused by the exhaust gas.

13. A method as in claim 8 further comprising
forming a water spray assembly coupled to the exhaust conduit for cooling the exhaust gas to be below an auto-ignition temperature of the hydrocarbon contaminants.

14. A method as in claim 8 further comprising
forming a water spray assembly coupled to the exhaust conduit for spraying water onto the exhaust gas to reduce a temperature of the exhaust gas.

15. A system comprising
a treatment chamber, wherein the treatment chamber is configured to contain a contaminated soil, wherein the contaminated soil comprises hydrocarbon contaminants, wherein the treatment chamber comprises an inlet configured for accepting a heated gas to the treatment chamber, wherein the treatment chamber comprises an outlet configured for output an exhaust gas from the contaminated soil;
an exhaust conduit coupled to the outlet;
a porous material disposed in the exhaust conduit for restricting mean free paths of the exhaust gas.

16. A system as in claim 15 further comprising
a temperature measurement element in the exhaust conduit, wherein the temperature measurement element is coupled to the heated gas for regulating a temperature of the exhaust gas to be below an auto-ignition temperature of the hydrocarbon contaminants.

17. A system as in claim 15 further comprising
a hydrocarbon concentration measurement element in the exhaust conduit, wherein the hydrocarbon concentration measurement element is coupled to the heated gas for regulating a flow of the heated gas so that a concentration of the hydrocarbon contaminants is outside a range of flammability of the hydrocarbon contaminants.

18. A system as in claim 15 further comprising
an isolation valve for isolating downstream equipment;
a relief chimney for directing the exhaust gas to a relief chimney during an explosion caused by the exhaust gas.

19. A system as in claim 15 further comprising
a water spray assembly coupled to the exhaust conduit for cooling the exhaust gas to be below an auto-ignition temperature of the hydrocarbon contaminants.

20. A system as in claim 15 further comprising
a water spray assembly coupled to the exhaust conduit for spraying water onto the exhaust gas to reduce a temperature of the exhaust gas.
